(19) United States
(12) Patent Application Publication
(10) Pub. No.: US 2010/0266722 A1
(43) Pub. Date: Oct. 21, 2010

(54) Food Product And Method

(76) Inventor: Jack F. Hudson, Tepquesta, FL (US)

Correspondence Address: MCHALE & SLAVIN, P.A., 2855 PGA BLVD, PALM BEACH GARDENS, FL, 33410, US

(21) Appl. No.: 12/425,006

(22) Filed: Apr. 16, 2009

(51) Int. Cl. B65D 81/32; B65D 85/16; A23K 1/18

(52) U.S. Cl. 426/2; 426/115; 426/394

(57) ABSTRACT

A food product and method are provided. The food product includes a bundle of grass leaves secured together by a wrapper. A container of a supplemental material is associated with the wrapper for distribution with the bundle. The food product including wrapper and container are pressed to extract liquid from the grass leaves and simultaneously rupture the container to release its contents for mixing with the extracted liquid. The resulting pulp, wrapper and container are separated from the liquid. The liquid can then be consumed as part of a human's diet.

### FIELD OF INVENTION

The present invention relates to a food product including a quantity of grass leaves retained in a bundle by a wrapper. A container is secured to the bundle by the wrapper and can contain a material to be dispersed in liquid squeezed from the grass leaves to form a liquid food product ingestible by a human.

### BACKGROUND OF THE INVENTION

In recent years, there has been an increase in interest in nutrition and food products to provide that nutrition. Much more is known today about improved nutrition and how it can provide an improvement in health. Many advances have been made in the forms of food for consumption and means to change food form for convenience of consumption and improvement of available nutrition. In addition, many foods are being “rediscovered” for their nutrition and health benefits. However, many foods that are nutritious are inconvenient or unappealing to eat. Much has been written about foods and nutrition but, some writings must be reviewed with caution because the authors, while seemingly knowledgeable, are not making such information to some consumers suspect.

Recent findings on health benefits include, e.g., that macular degeneration can be retarded with vitamins and that some foods can help prevent cancer. But, the nutritional value of food can change with storage and cooking so its benefits can be lost. Some nutritious foods are also just not appealing or easy to consume. It is thus important to provide food that is both convenient to consume and appealing to the consumer while providing the desired nutrition. These goals are often at cross purposes since consumers want to eat what they are accustomed to eat and will often subordinate nutrition for familiarity and/or convenience.

It has been reported that humans ate grasses as a source of food back into antiquity even without realizing their nutritional value. However, eating a grass is not traditional or necessarily appealing. To worsen appeal, grass is viewed by some as food for four legged animals, not people. The nutritional values of grasses are now known and readily available, but that does not make them desirable to eat to a large portion of the human population. It would be desirable to provide a way of delivering grass as a food source in a convenient manner and to be able to fortify it with additional nutrients or ingredients to enhance its appeal. Thus, it is a goal to provide grass leaves as a food to humans in a form that makes them both appealing and convenient for consumption.

### SUMMARY

The present invention involves the provision of a food product including a quantity of grass leaves secured in bundle form by a wrapper. The wrapper surrounds a portion of the bundle. One or more containers are secured to the bundle by the wrapper. The container(s) can contain a consumable material such as a nutrient, flavorant, odorant, colorant, herb, sweetener and medicament. The food product is configured for sale in a grocery store, preferably at the fresh produce counter and use as an integral unit in subsequent processing. One or more bundles of grass can be contained in a package, such as a bag, if desired. Preferred grasses include those from the genus Triticum.

The present invention also involves the provision of a method of delivering food for human consumption. The method includes forming a bundle of grass leaves. The grass leaves are relatively fresh containing at least about 50% by weight water. A wrapper is used to secure the grass leaves in the bundle of desired weight or quantity. At least one container is secured to the bundle with the wrapper. The container encloses at least one consumable material selected from a group including a nutrient, flavorant, odorant, colorant, herb, sweetener and medicament. The bundle is distributed under refrigerated storage conditions. A consumer can apply force to the bundle, wrapper and container to separate the grass leaves into pulp and released water and simultaneously rupture the container to release the contents therein for mixing with the released water. The released water and contents can then be ingested as a drink. The separated pulp, wrapper and container can be discarded. A juicer can be used to apply the force.

### BRIEF DESCRIPTION OF THE DRAWINGS

FIG. 1 is a perspective view of a food product of the present invention.

FIG. 2 is an enlarged fragmentary perspective view of a wrapper portion of the food product showing details of the wrapper and containers associated therewith.

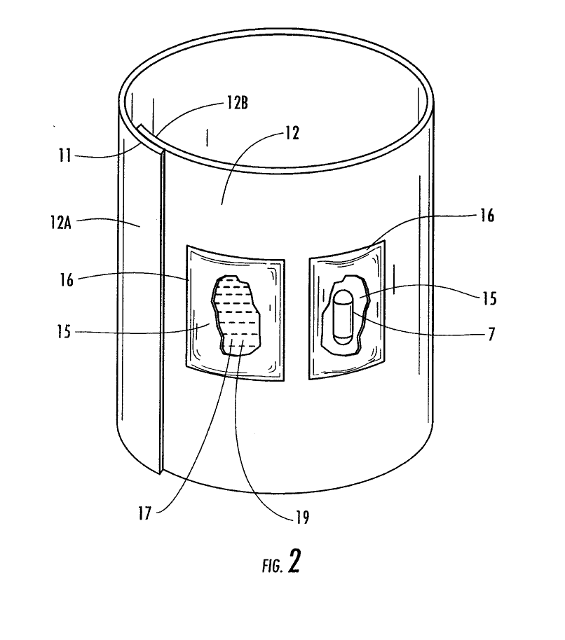

### DETAILED DESCRIPTION OF THE INVENTION

While the present invention is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated.

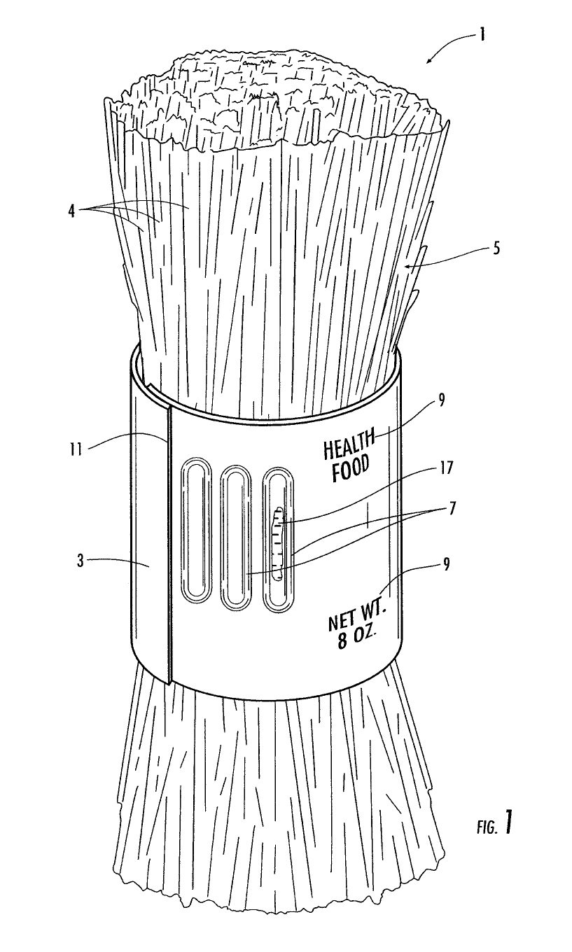

FIG. 1 shows a food product designated generally 1. The food product 1 includes a wrapper 3 to secure a plurality of discreet food pieces 4 in a bundle 5. The wrapper 3 secures, directly or indirectly, at least one container 7 to the bundle 5. The food product 1 is adapted for sale at a store or the like and for consumption by a human after preparation. One or more bundles 5 may be contained in a package, such as a plastic bag (not shown).

The food pieces 4 include green grass leaves in a relatively fresh condition and have a total moisture content of at least about 50% and more preferably at least about 70% by total weight of the food pieces. The grass leaves can be from any suitable genus of plants and are preferably from grain producing plants and more preferably the Triticum genus which includes wheat, barley, oats and rye. Wheat grass leaves are preferred. In a particularly preferred embodiment, the grass leaves include at least a majority by weight at least one of wheat, barley, oats and barley grass. Mixtures of species may also be used. The grass leaves are preferably harvested for use early in the growth cycle and when the nutritional value is about maximum, for example, before the plant reaches the second leaf or jointing stage or when the grass leaves have reached a length in the range of between about 2 inches and about 8 inches. The nutritional value of the grass leaves at this stage of growth is relatively high by weight of the grass leaves. The weight of the grass leaves in a bundle 5 is preferably greater than about 30 grams and more preferably in the range of between about 30 grams and about 450 grams.

The wrapper 3 may be any suitable wrapper that is approved for food contact use. It may be made of a suitable plastic, polymeric material, paper or the like. The wrapper may be an edible material. Paper can contain vegetable fiber as a constituent. A preferred wrapper material can be based on starch and/or protein material. It may include additives or coatings to control properties such as water absorption, strength and printability. Lipids can be used as a coating for water resistance. If desired, the wrapper material may be of a type that can be printed with indicia 9 such as product type, net weight and the like. A preferred material is rice paper that is made from rice plant components. Rice paper is commonly used with food products. The wrapper 3 may be seamed together at 11 as with a suitable food approved adhesive. Such adhesives can be starch based or other suitable food approved adhesive. The wrapper 3 can be in the form of a tube with a continuous sidewall 12 which has overlapping edge margin portions 12A, 12B forming the seam 11. The seam 11 may be a longitudinally or a helically extending seam. It is preferred that the seam 11 be formed by securing marginal edge portions 12A, 12B of the sidewall 12 together after the wrapper 3 is wrapped around the bundle 5.

The wrapper 3 is used to carry at least one container 7 and associate it with the bundle 5 for distribution as an integral food product. As shown, there is a plurality of containers 7. Any suitable number of containers 7 may be provided. The container 7 is secured to the wrapper 3 in any suitable manner, such as adhesion or may be positioned in a pocket 15 formed in/on the wrapper 7. The pocket 15 may be formed by securing a panel 16 of material in overlying relationship to a portion of the sidewall 12 and forming a seal around the margins of the panel 16. The panel 16 and the sidewall 12 can define the pocket 15 and can function as a container 7. The pocket 15 may also be formed by folding porting of the sidewall 12 over onto itself and securing adjacent portions together. By being secured to the wrapper 3, the container 7 is secured to the bundle 5. A container 7 may be of any form suitable to contain a material 17 therein for use with the food pieces 4. The container 7 is preferably rupturable in subsequent processing of the food product 1 as described below. The structure of a container 7 is such as to store the contained material 17 over the anticipated shelf life of the food product 1. It is preferred that the material 17 be in liquid form, including a liquid with dissolved material (solution), a slurry or a mixture, and thus, it is preferred that the container 7 be substantially insoluble to the contained material for at least the anticipated shelf life of the food product 1. The liquid can include any suitable ingestible liquid including water, lipid, acid and alcohol. Gels and solids may also be used to provide the material 17. If a solid is used, it is preferably coated or otherwise treated or encapsulated to prevent dissolving during storage. The coating or encapsulant provides a container for the solid. The liquid in the grass can be used to dissolve or disperse the solid after the solid is exposed by rupturing the protective material. Suitable container material for water based materials 17 can be starch and/or protein based materials, polyvinylacetate (PVA) containing material, hydrocolloids and lipid containing or coated materials. Such materials are well known in the art. Upon application of force to a container 7, it will rupture and the material 17 can be released for admixture with water released from the plant pieces 4. It is to be noted that the container 7 may be an integral part of the wrapper 3. For example, the pocket 15 may be constructed to contain the material 17 therein by sealing the pocket 15 to form a sealed storage chamber 19 to function as a container 7.

The material 17 can be any suitable material selected from a group including nutrients such as vitamins and minerals, herbs, flavorants, sweeteners (like honey or high intensity sweeteners), odorants, colorants and medicaments, including herbal medicines. The material 17 can be normally substantially dry material dissolved in a liquid such as alcohol, water and lipids.

In use, the food product 1 is assemble and distributed to points of sale under refrigerated conditions. A consumer can purchase the product and store it at a point of use also preferably under refrigerated conditions. The food pieces 4, for example grass leaves are formed into a bundle. The grass leaves are secured in the bundle arrangement with a wrapper 3. The wrapper 3 may be secured in place by forming the seam 11 after wrapping around a bundle 5. At least one container 7 and the material 17 therein are secured to the bundle 5 with the wrapper 3. After forming the food product 1, it is distributed under refrigerated storage conditions preferably in a high moisture environment. A consumer then further processes the food product 1 for consumption. Preferably, a person simultaneously applies force to the bundle 5, wrapper 3 and container 7 to thereby separate the vegetable food pieces 4 into pulp and released water which can contain other material from the food pieces 4 such as vitamins, minerals, starches, proteins and fiber. The container(s) 7 is/are ruptured by application of force to release the contents 17 therein for mixing and separation with the released water. The pulp, container 7 and wrapper 3 are separated from released water and released container contents 17. The released water and released container contents 17 can then be consumed by a human. The water separated from the food pieces can and is likely to also contain one or more components of the food pieces in addition to the separated water, including soluble and insoluble components, such as vitamins, minerals, starches, proteins and fiber forming a solution and/or a slurry or mixture therewith in the event solids are released during the application of force. The pulp, container 7 and wrapper 3 can be discarded. The application of force to the food product 1 can be accomplished by using a juicer (not shown) as are known in the art. Some juicers use one or more screws to apply force to vegetable matter to effect liquid/solid separation.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A food product comprising:
a quantity of grass leaves containing at least about 50% by total weight water;
a wrapper surrounding a portion of the grass leaves securing the grass leaves in a bundle; and
at least one container associated with the bundle by the wrapper, said container being made of a rupturable material and enclosing at least one consumable material selected from a group including nutrients, flavorants, sweeteners, odorants, colorants, herbs and medicaments.

2. The food product of claim 1 wherein the grass leaves including grass leaves from the genus Triticum.

3. The food product of claim 2 wherein the grass leaves including grass leaves of at least one of wheat, barley, oats and rye.

4. The food product of claim 1 wherein the grass leaves including at least a majority by weight, wheat grass leaves.

5. The food product of claim 4 wherein the container including at least one capsule with at least a portion of said consumable material therein.

6. The food product of claim 1 wherein the container including at least one capsule with at least a portion of said consumable material therein.

7. The food product of claim 1 wherein the wrapper including paper.

8. The food product of claim 7 wherein the paper including at least one of starch and protein.

9. The food product of claim 8 wherein the paper including vegetable fiber.

10. The food product of claim 7 wherein the paper including rice paper.

11. The food product of claim 1 wherein the grass leaves containing at least about 70% by weight water.

12. The food product of claim 11 wherein the grass leaves in the bundle having a weight in the range of between about 30 grams and about 450 grams.

13. The food product of claim 1 wherein the container containing at least one of liquid, gel and solid.

14. A method of delivering a food for human consumption, the method including:
forming a bundle of grass leaves said grass leaves containing at least about 50% by weight water;
securing the grass leaves in the bundle with a wrapper;
associating at least one container with the bundle with the wrapper, said container enclosing at least one consumable material selected from a group including nutrients, flavorants, odorants, colorants, sweeteners, herbs and medicaments; and
distributing the bundle under refrigerated storage conditions.

15. The method of claim 14 including applying force to the bundle, wrapper and container and thereby separating the grass leaves into pulp and released water and rupturing the container to release the contents therein for mixing with the released water.

16. The method of claim 15 wherein the pulp, container and wrapper are separated from released water and released container contents.

17. The method of claim 16 wherein the released water and released container contents being consumed by a human.

18. The method of claim 16 wherein the separated water also containing at least one component of the grass leaves in addition to the separated water.

19. The method of claim 18 wherein the at least one component separated from the grass leaves including at least one from the group of vitamins, minerals, starches, proteins and fiber.

20. The method of claim 16 wherein the wrapper including edible paper.

21. The method of claim 20 wherein the paper including at least one of starch and protein.

22. The method of claim 21 wherein the paper including rice paper.

23. The method of claim 16 wherein the force being applied to the bundle, wrapper and container in a juicer.

24. A method of delivering a food for human consumption, the method including:
forming a bundle of grass leaves said grass leaves containing at least about 50% by weight water;
securing the grass leaves in the bundle with a wrapper;
distributing the bundle under refrigerated storage conditions;
applying force to the wrapper and the bundle to separate the grass leaves into liquid and pulp from the grass leaves;
separating the pulp and wrapper from the liquid; and
consuming the separated liquid.

25. The method of claim 24 wherein the force being applied to the bundle and wrapper in a juicer.

26. The method of claim 25 wherein the grass leaves including grass leaves from the genus Triticum.

27. The method of claim 26 wherein the grass leaves including at least a majority by weight wheat grass leaves.
